(19) United States
(12) Patent Application Publication
(10) Pub. No.: US 2016/0267412 A1
(43) Pub. Date: Sep. 15, 2016

(54) Electronic Project Checklist and Data Management System

(71) Applicants: Timothy Reed, Pittsburgh, PA (US); Amanda Gail Bolyard, Pittsburgh, PA (US)

(72) Inventors: Timothy Reed, Pittsburgh, PA (US); Amanda Gail Bolyard, Pittsburgh, PA (US)

(21) Appl. No.: 14/846,379

(22) Filed: Sep. 4, 2015

Related U.S. Application Data
(60) Provisional application No. 62/045,818, filed on Sep. 4, 2014.

(51) Int. Cl. G06Q 10/06

(52) U.S. Cl. CPC G06Q 10/06313; G06Q 10/063114

(57) ABSTRACT

A system, method, and computer readable medium for electronic project and data management is described. The system is comprised of a central database, a server controller for the database, an interface with electronic access to the database for vendor and client personnel, and a foreman device. The device can create, view, and edit work-related documents, such as inspection checklists, and upload those documents to the database either contemporaneously or via manual synchronization. The device may also contain maps, a daily log, specifications, work codes, and project alerts. The interface provides access to project documents, member connections, and project alerts. Documents requiring approval automatically move through the chain of command as approved or rejected for revision. All members are automatically linked to project documents, and no paper is required for system operation. The method of carrying out the steps above is programmatically operated via a computer readable medium.

### CROSS REFERENCE TO RELATED APPLICATIONS

The present application claims priority to U.S. Provisional Application No. 62/045,818, filed Sep. 4, 2014, which is hereby incorporated by reference.

### BACKGROUND OF THE INVENTION

1. Field of the Invention

The present disclosure relates to an electronic document management system that involves preparing inspection test plans, reviewing current regulatory code and specifications, completing checklists and inspection forms in the field, recording the documents electronically, and saving the documents for later access by involved project members. The system disclosed herein incorporates mobile platforms, website interfaces, and a central repository to collect, store, provide access to, and notify project members of document data.

2. Description of Related Art

There are a number of problems that may arise in managing projects where paper forms are filled out in the field to document the work being performed. Primarily, paper forms can be lost between when they are created in the field and when they need to be entered into a document management system. When these forms are not registered with the system, whether they were lost or never completed, the work to be documented must be performed over again. Repeating undocumented work sometimes comes at an extreme cost to the vendor.

Paperwork that requires completed checklists can cause further issues, for example, like those in field inspection activities. Completing checklists accurately becomes difficult if an inspector attempts to recall and document his observations hours later after visiting multiple locations. There exists a need to simplify and encourage contemporaneous documentation of work in the field.

Moreover, once those forms and checklists are completed, there exists no direct link to integrate the documents into the management system. Currently, it is a manual process to retrieve all forms from the field, scan the documents into electronic files, and separately upload those files to the document management system. Collecting, scanning, and uploading require additional overhead for the manual labor involved.

Finally, from a management perspective, projects with numerous involved parties can quickly become time consuming and tedious with regard to documentation and communication. Surplus time spent on keeping parties informed of, accountable for, and connected to documentation leads to wasted costs. Here too exists a need to initialize and structure a project to easily engage all parties and keep them apprised as the project continues.

### SUMMARY OF THE INVENTION

In view of the foregoing, a system, method, and computer readable medium for an electronic project and data management system are provided herein.

The electronic data management system comprises a central database accessible via a server controller, the central database being configured to store project information, project-related documents, and an archive of past projects and approved project-related documents. The system also comprises an interface, accessible by devices with web browsers and internet connectivity, for data management with electronic access to the central database. The interface for data management comprises a web portal, the web portal being configured for a user to view, create, and edit the project information in the central database, and view, create, and edit member connections to projects. The user first logs in securely before the user can view, create, or edit information from the central database. The web portal automatically provides member access to the project-related documents when a new member connection to the project is created for the user. The interface allows or denies the logged-in user access to the project information, and allows the logged-in user to, or prevents the logged-in user from, editing the project information from the central database, whereby the logged-in user's ability to access or edit changes is determined by the user's role and membership in selected projects. The system also comprises a foreman's device with electronic access to the central database.

The project-related documents are automatically connected to members higher up a review hierarchy when the project-related documents are approved by members lower down the review hierarchy, and the project-related documents are automatically connected to the members lower down the review hierarchy when the project-related documents are rejected by the members higher up the review hierarchy. Managing project members may create inspection test plans, edit the inspection test plans, and save the inspection test plans to the central database, the inspection test plans being configured to be accessed by the foreman's device. Inspection checklists can be saved to the inspection test plans.

The foreman's device is configured to run software adapted for a foreman to view project information, create and save electronic project-related documents, and transmit the project-related documents to the central database. The foreman must use security credentials to log in to the foreman's device and access project-related data. The foreman's device is configured to receive, view, and edit the project-related data as made accessible by the foreman's project connections. The foreman's device is configured for the foreman to create new inspection checklists, edit the inspection checklists, submit the inspection checklists to the central database, attach photographs to the inspection checklists and submit the inspection checklists to the central database. The central database is configured to store inspection checklists and templates for creating the inspection checklists, and the templates are configured to be edited, saved, and deleted from the central database via the foreman's device, or other electronic access by a member with sufficient administrative permission. The project members receive alerts when important project updates occur or when a new document awaits their approval or revision.

The foreman's device is connected to a synchronous data connection, and the foreman's device is configured to transmit information to the central database with the synchronous data connection, or transmit information by the foreman manually triggering synchronization if the foreman's device was operated previously without data connectivity. The foreman's device is further configured to access maps, daily logs, and alerts as each relate to a selected project.

The method of managing electronic project-related data comprises the steps of: displaying an interface for data management; transmitting information between the interface and a central database; storing project information, project-related documents, and an archive of past projects and approved project-related documents in the central database; displaying the interface through a web portal for a user; displaying existing project data, creating new project data, and editing the existing project data in the central database; displaying existing member connections to projects, creating new member connections to projects, and editing the existing member connections to projects in the central database; providing a new member access to the project-related documents when a new member connection to a project is created for the user; receiving security credentials from the user before the user can view or edit information from the central database; conditioning the accessibility of project information based on the user's security credentials; and conditioning the user's ability to edit project information based on the user's security credentials.

The method further comprises the steps of connecting the project-related documents to members higher up a review hierarchy when the project-related documents are approved by members lower down the review hierarchy; connecting the project-related documents to the members lower down the review hierarchy when the project-related documents are rejected by the members higher up the review hierarchy; creating inspection test plans, editing the inspection test plans, and saving the inspection test plans to the central database; transmitting the inspection test plans to a foreman's device and saving inspection checklists to the inspection test plans; transmitting project information to the foreman's device, creating and saving electronic project-related documents on the foreman's device, and transmitting the project-related documents to the central database; receiving security credentials from the foreman, logging the foreman into to the foreman's device, transmitting project-related data to the foreman's device, displaying project-related data on the foreman's device, and editing project related data on the foreman's device as defined by the foreman's project connections; creating new inspection checklists on the foreman's device, editing the inspection checklists on the foreman's device, and transmitting the inspection checklists from the foreman's device to the central database attaching photographs to the inspection checklists and transmitting the inspection checklists to the central database; storing inspection checklists and templates for creating the inspection checklists; editing templates, saving templates, and deleting templates from the central database via the foreman's device or other electronic access by a member with sufficient administrative permission; and alerting the user when important project updates occur or when a new document awaits their approval or revision.

The method further comprises the steps of: connecting the foreman's device to a synchronous data connection and transmitting data from the foreman's device to the central database with the synchronous data connection, or alternatively, transmitting data to the central database when prompted manually by the foreman's device after previously being operated without data connectivity; and displaying maps, daily logs, and alerts on the foreman's device as each relate to a selected project.

The computer readable medium contains a program for use in the electronic data management system network, and the program is configured to carry out the steps of the method described in the preceding paragraphs. The medium may be located with the system's central database and server controller, or alternatively, may be located elsewhere in the system in communication with the central database, foreman's device, and other user-accessible web portals.

The foregoing and other features and characteristics will become more apparent upon consideration of the following description and the appended claims with reference to the accompanying drawings, all of which form a part of this specification, wherein like reference numerals designate corresponding parts in the various figures. As used in the specification and the claims, the singular form of “a”, “an”, and “the” include plural referents unless the context clearly dictates otherwise.

### BRIEF DESCRIPTION OF THE DRAWINGS

Some of the advantages and features of the invention have been summarized hereinabove. The illustrative embodiments described in the detailed description, drawings, and claims are not meant to be limiting. Other embodiments may be utilized and other changes may be made without departing from the spirit or scope of the subject matter presented herein. These embodiments, along with other potential embodiments of the device, will become apparent to those skilled in the art when referencing the following drawings in conjunction with the detailed descriptions as they relate to the figures.

FIG. 1 is a diagram of all physical system components, including mobile devices in the field, central database with a server controller, and web-accessible devices controlled by vendor and client personnel;

FIG. 2 is a flowchart of the actions a user can take in operating the application on the mobile device;

FIG. 3 is a flowchart of the lifecycle of a checklist in the electronic document management system;

FIG. 4 depicts one embodiment of a screen for use by a foreman in the field, displaying an inspection test plan, (“ITP”) window according to a first embodiment;

FIG. 5 depicts one embodiment of a screen for use by a foreman in the field, displaying all active and completed checklists for a selected ITP;

FIG. 6 depicts one embodiment of a screen for use by a foreman in the field, displaying a selected checklist to be completed and submitted by the foreman; and

FIG. 7 depicts one embodiment of a screen for use by vendor personnel, displaying a management window for a vendor to search for work based on search criteria.

FIG. 8 depicts charts showing the purposes of the present invention.

FIG. 9 depicts a login screen.

FIG. 10 depicts a choose project screen.

FIG. 11 depicts a choose area screen.

FIG. 12 depicts a station and offset definition screen.

FIG. 13 depicts the first of three building inspection test plans screens.

FIG. 14 depicts an activities screen; the second of three building inspection test plans screens.

FIG. 15 depicts a checklists screen; the third of three building inspection test plans screens.

FIG. 16 depicts a daily log screen.

FIG. 17 depicts a maps screen.

FIG. 18 depicts a synchronization screen.

FIG. 19 depicts an alerts screen.

FIGS. 20-21 depict screens showing the creation of alerts.

FIG. 22 depicts a review checklist screen.

FIG. 23 depicts a history screen.

FIG. 24 depicts a managing projects screen.

FIG. 25 depicts a managing people and roles screen.

FIG. 26 depicts a checklist archive/search screen.

FIG. 27 depicts a resource library screen.

### DETAILED DESCRIPTION OF THE DRAWINGS

It is to be understood that the embodiments described hereinafter may assume many alternative variations and configurations. It is also to be understood that the specific components, devices, and features illustrated in the accompanying drawing figures and described herein are simply exemplary and should not be considered as limiting.

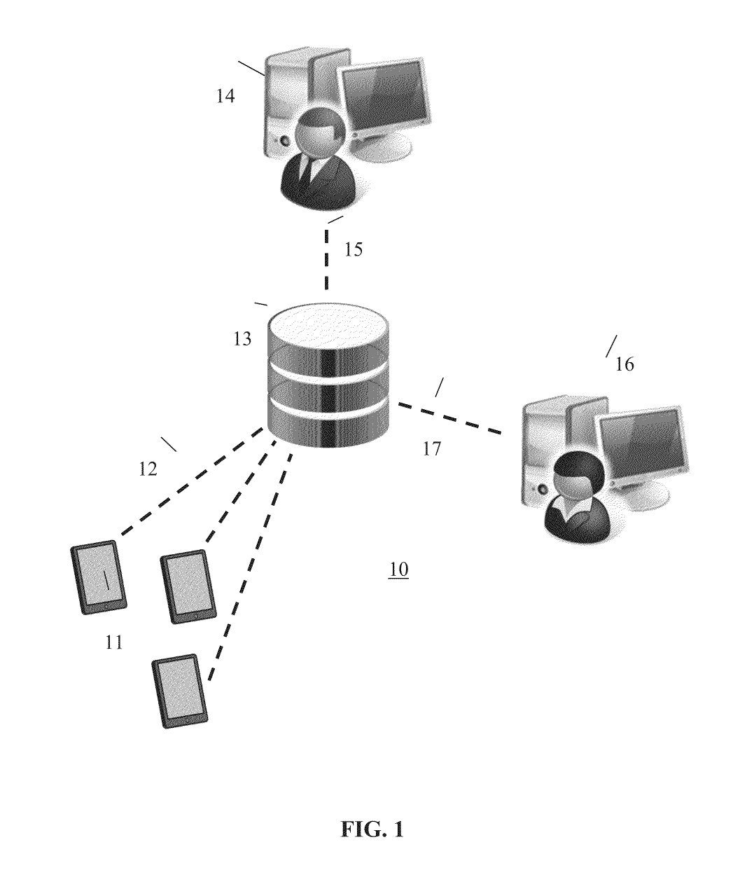

FIG. 1 illustrates the relationship between each technological component of the data management system as a web diagram 10. In one embodiment, foremen operate at least one computer tablet 11 out in the field to complete work checklists. The tablet 11 utilizes a data connection 12 to transmit data to and receive data from a central database with a server controller 13. Data stored on the central database 13 can also be accessed by a vendor personnel's web portal 14, which communicates with the central database 13 via a data connection 15. The central database with server controller 13 can house the computer-readable medium, although it may be housed elsewhere in the system given sufficient communication with the nodes. A client personnel web portal 16 can access data from the central database 13 via its own data connection 17. All data connections 12, 15, 17 communicate requests to the central database 13 through its server controller.

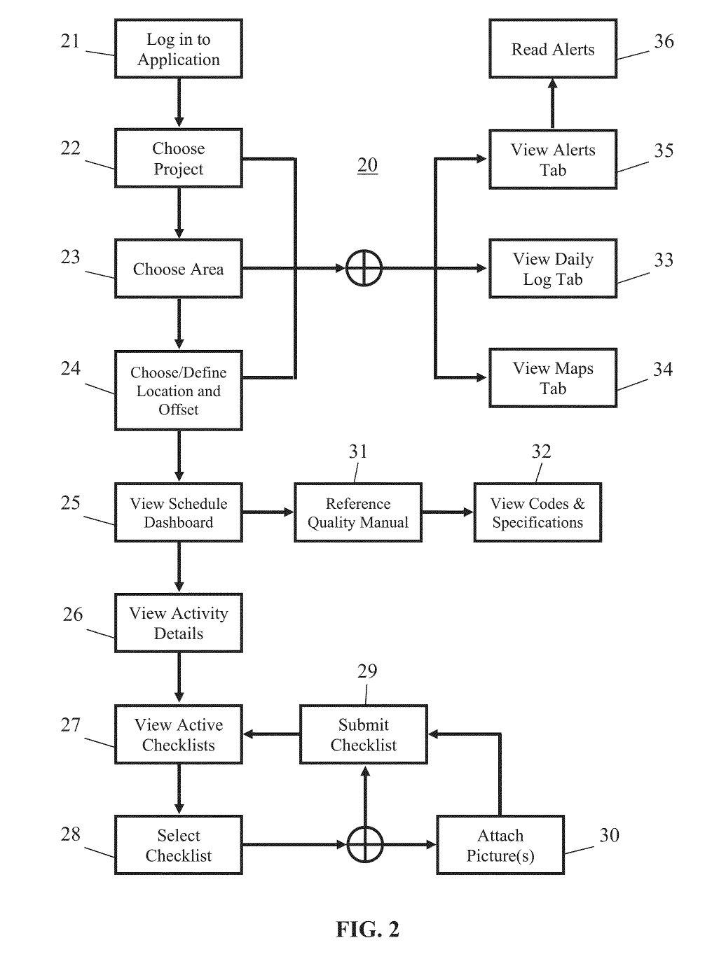

FIG. 2 illustrates one embodiment for the mobile device's interface workflow, as shown in flowchart 20. The user first must log into an application 21. After logging in, the user may choose a project 22, choose a work type/area 23, and choose/define a work location 24. Once project, area, and location parameters are set, the user may view an ITP dashboard 25. From the ITP dashboard 25, the user may select and view an activity's details 26 and further view the active checklists 27 for a selected activity 26. Once viewing active checklists 27, the user may select a checklist 28 to be created or modified. After completing the selected checklist 28, the user may submit a checklist 29, or attach a picture 30 prior to submission 29. After submitting changes to the checklist 29, a user is redirected to the list of active checklists 27.

Also depicted in the flowchart 20 of FIG. 2, when viewing the ITP dashboard 25, the user may view a quality manual reference 31 or view codes and specifications 32 for the chosen work type/area 23. As an alternative to choosing the project 22, work type/area 23, or location 24, a user may also navigate to a daily log tab 33, a maps tab 34, or an alerts tab 35. The user may journal standard project information such as date, location, or current weather in the daily log 33. The user may view project-related geographical information in the maps tab 34. Finally, the user may view all of their important notifications in the alerts tab 35 and read individual alert information 36 in a separate window.

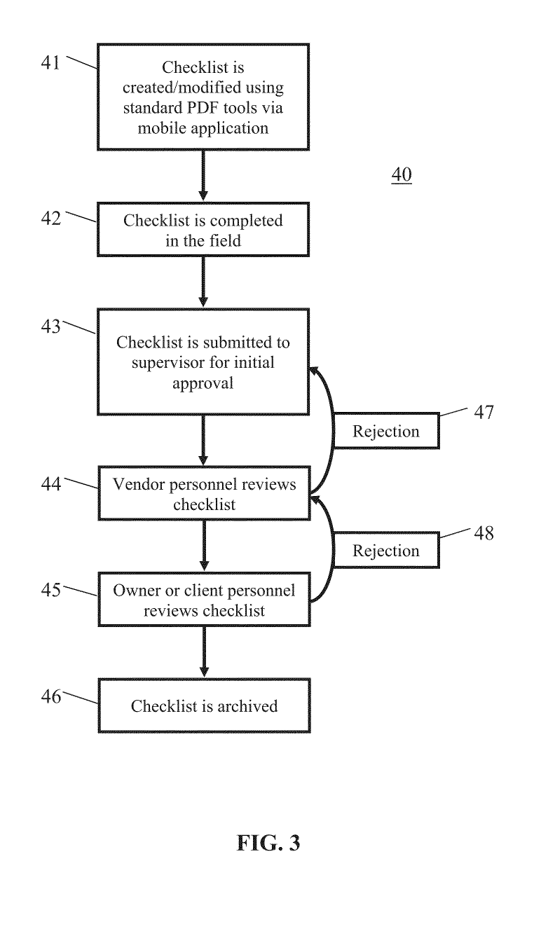

FIG. 3 illustrates the lifecycle of a checklist, as depicted in a flowchart 40. The checklist begins by being created or modified from an existing checklist 41. Once completed, the checklist is submitted to a foreman supervisor 43 for approval. If approved, the checklist is then reviewed by vendor personnel 44. From the vendor personnel, review of the checklist moves to the owner/client personnel for final approval 45. If approved by all involved parties, the checklist is archived 46. A checklist may be bumped back in the process, for example, by a vendor personnel rejection 47 or an owner/client personnel rejection 48, in which case review and responsibility revert to the foreman supervisor 43 or vendor personnel 44, respectively.

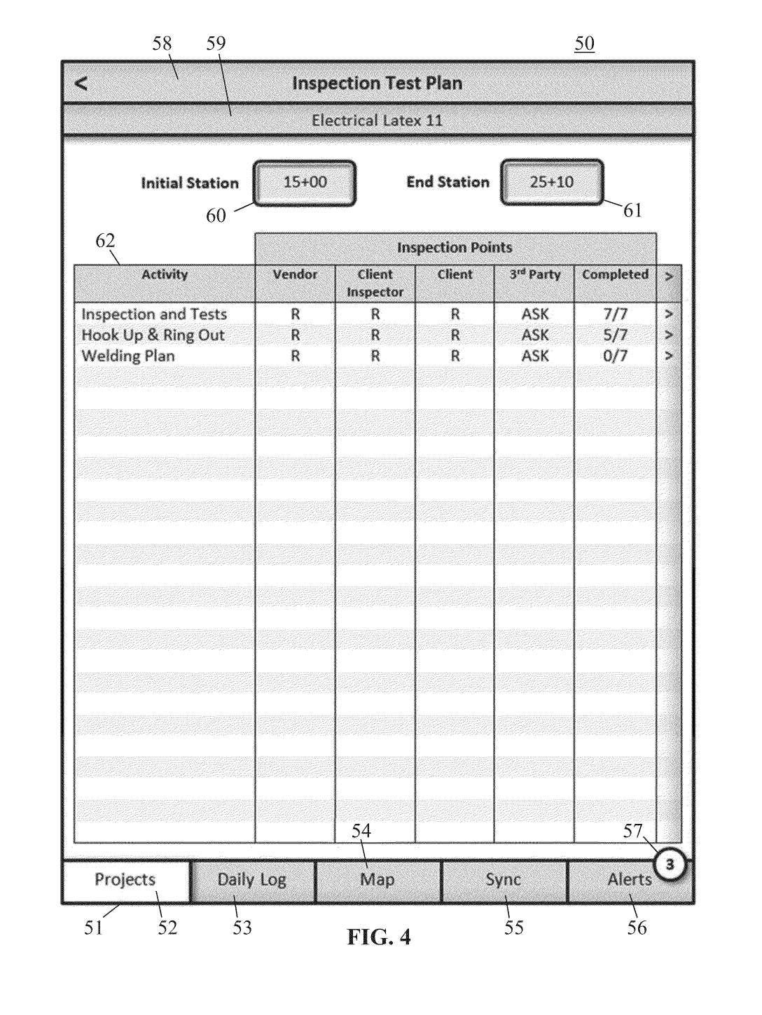

FIG. 4 depicts a screen for use by a user, such as a foreman, particularly an ITP dashboard 50, as viewed on a mobile device. This screen gives an overview of the total ITP for a given area. This will show each activity for the ITP, as well as identifiers for all of the primary responsible parties (Inspection Points). It will indicate if all the checklists for any given activity have been completed or not. The user will be able to select an activity and navigate to a view that displays a more in-depth set of information relating to that specific activity. At the bottom of the screen is a fixed navigation bar 51, which includes navigation controls such as a projects tab 52, a daily log tab 53, a map tab 54, a synchronization tab 55, and an alerts tab 56. The alerts tab 56 contains an alerts icon 57 that displays how many alerts are active. A topmost title bar 58 displays the window's name as “Inspection Test Plan,” and below it a project title bar 59 displays the current project. Below those, entry/display boxes for an initial station 60 and an end station 61 specify the route of the ITP. Finally, a test plan table 62 specifies the activities to be completed and their state of completion.

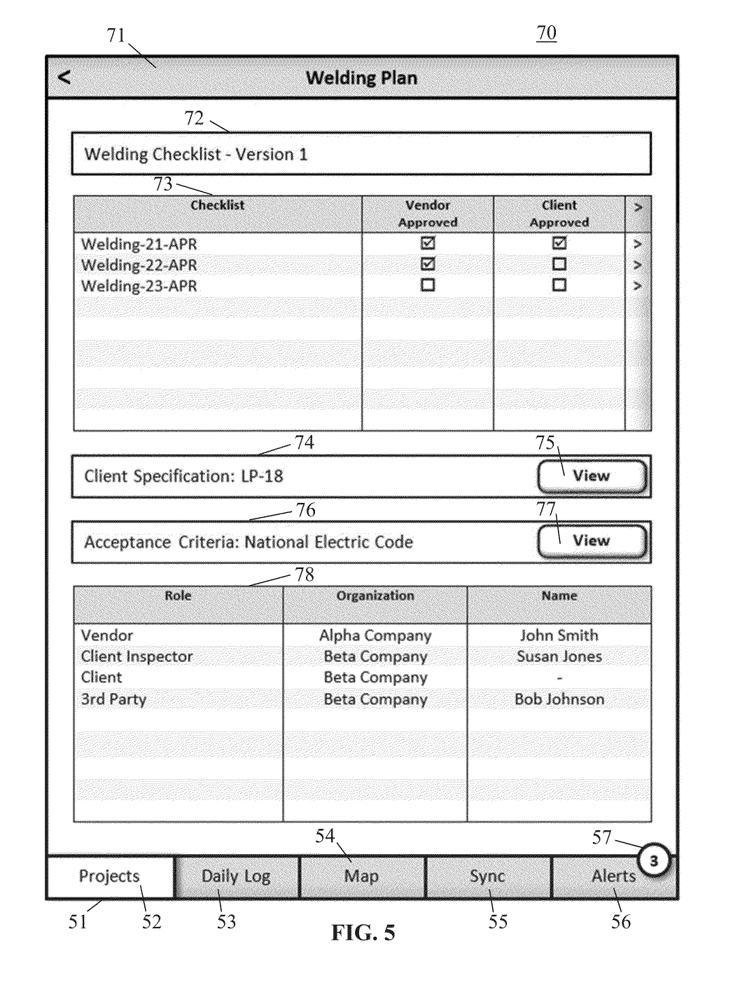

FIG. 5 depicts a screen which serves as an extension to the previous ITP screen. It allows the user to view both the client specification for the activity as well as the related acceptance criteria. Displaying of criteria and specifications on this screen would be done in “pop-up” format and is intended to be used by the end-user for refreshing themselves on the details of the respective documents. This view will show all checklists that are active for a given activity (both completed and yet-to-be completed). It will be used by the user to select the checklist that they want to complete and to begin the inspection process. A list of the responsible parties will be displayed as they relate to the identifies/abbreviations listed on the previous ITP screen. This screen is for use by a foreman as designed in one embodiment, particularly a checklist overview window 70 for the selected ITP, as viewed on a mobile device. In this embodiment, the navigation bar 51 is constant from window to window. As in each window, the navigation bar 51 contains navigation controls such as the projects tab 52, the daily log tab 53, the map tab 54, the synchronization tab 55, and the alerts tab 56. The alerts tab 56 contains an alerts icon 57 that displays how many alerts are active. An ITP checklists title bar 71 displays the type of checklists being viewed, in this case for a “Welding Plan.” A checklist version display label 72 depicts what version of the checklist is being used. A checklist table 73 displays all checklists for the ITP, including each checklist's progress. A checklist specification label 74 displays the type of client specification being used for the ITP. Clicking a view specification button 75 might overlay a window to read the specification. A checklist criteria label 76 displays the type of acceptance criteria being used for the ITP. Clicking a view criteria button 77 might overlay a window to read the acceptance criteria. An ITP member table 78 displays all involved members in the ITP, such as vendor, client, and third parties.

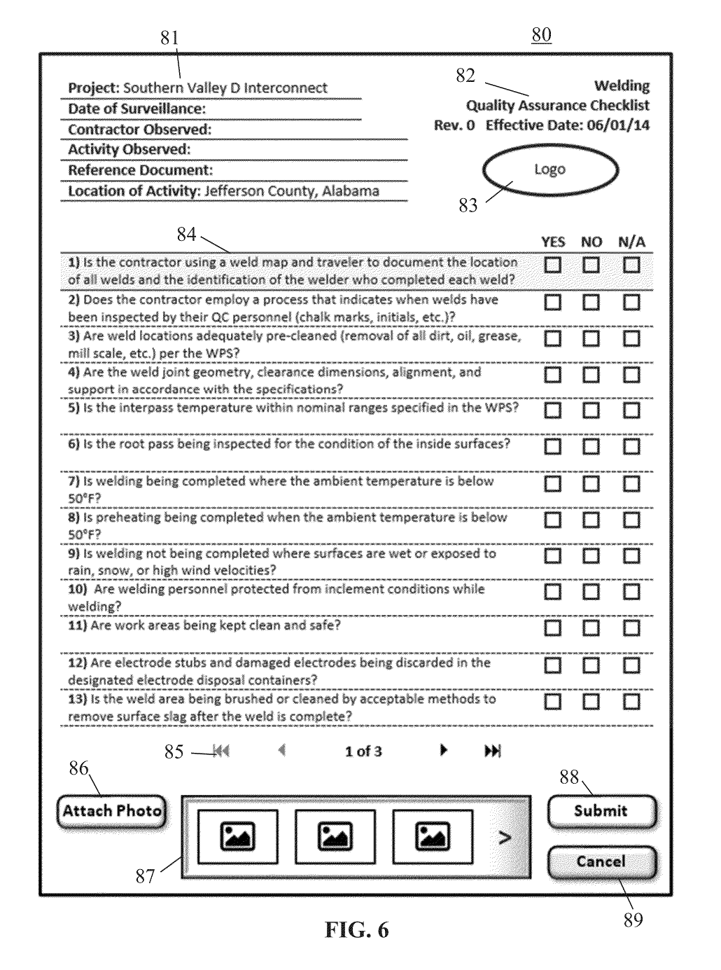

FIG. 6 depicts a screen for use by a foreman as designed in one embodiment, particularly a checklist editor window 80 for a selected checklist, as viewed on a mobile device. The checklist editor window displays relevant checklist project information 81, checklist type information 82, and a vendor's logo 83 for verification. The checklist editor window contains an interactive checklist 84 that can be completed similarly to a paper checklist or a PDF checklist. Should the checklist span multiple pages, page navigation controls 85 can flip from page to page or front to back. The checklist editor contains an attach photo button 86 for taking or uploading site photos, which are displayed in a photo tray 87 as they are added. A user may submit a checklist upon completion with a submit button 88, or back out of the editor with a cancel button 89. This screen will contain the inspection checklist for the previously specified activity and location. It will contain a previously created version of a standard format PDF form and will allow the user to enter in the results of an inspection using a combination of touch-based entry and onscreen keyboards. The user will be able to attach photos of what they are currently inspecting and view thumbnails of previously taken photos that relate to that checklist. When a user has completed a checklist, he will be presented with an opportunity to confirm that he is ready to finish said checklist, and, if so, he will be able to supply a digital signature to finalize the checklist. Upon submission of a completed checklist, all answers and related photos will be saved and uploaded upon synchronization to DTG's central storage. Once a checklist has been transferred off of the tablet, it will begin its quality control lifecycle.

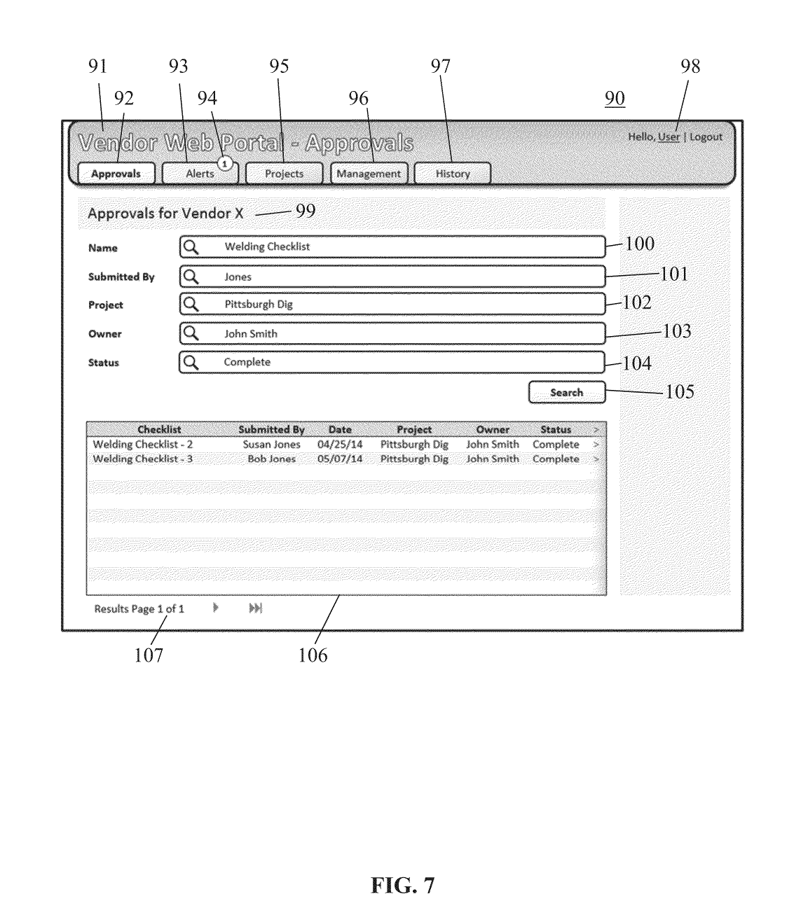

FIG. 7 depicts a screen for use by vendor personnel as designed in one embodiment, particularly a web portal approvals window 90, as viewed on any device with a web browser. A web page title bar 91 displays the current window, in this case for approvals by vendor personnel. The title bar also contains navigation controls, such as an approvals button 92, alerts button 93, projects button 95, management button 96, and history button 97. The alerts button contains an alerts icon 94 that displays the number of active alerts. The title bar also contains a login control 98 with displays the name of the current user. A vendor approvals label 99 displays the name of the vendor. Below, search or entry text fields are displayed for a document's name 100, submitting member 101, project name 102, project owner or client 103, and a document status 104. A search button 105 will trigger the retrieval of documents as specified by one or more of the text fields 100-104. Those results are displayed in a search results table 106, which may span multiple pages if a broad search was conducted. A user may flip from page to page or front to back using navigation controls 107 below. This screen is used as a work list for both vendor and owner client QC staff to review all submitted checklists as they relate to a specific project. The list of items to review would initially be shown in descending order by date, according to when the items were submitted. The user would be able to filter by multiple fields such as project name, person who submitted the checklist, who is currently responsible for the checklist, etc. From here the user selects a checklist and navigates to it for review One functional difference between the roles of vendor QC and owner client QC would be that the owner client would be able to view items from multiple vendors or to filer their queue to a single vendor.

The invention further includes a method of managing electronic project-related pipeline data. For example, the system can be used for document safety along a pipeline. As shown in FIG. 4, the interface provides an inspection test plan. For example a weld plan can be used to ensure that proper procedures have been followed during the steps of welding the pipeline. On FIG. 5, more detailed procedures are shown in regards to the welding plan. FIG. 6, shows examples of quality assurances that are gained by using the weld plan.

In one embodiment, in a first step, an interface for data management is used for providing a central point for managing an inspection using stored project related data. The method can include communications and messages, or events for transmitting information between the interface and a central database, in addition to transmission to other systems or field devices being used by users in related areas. Stored project information can include project-related documents, archives of past projects or approved project-related documents in the central database.

A web portal, portable handheld computer, mobile device, or field computer can be used for showing users existing project data, or creating new project data, and also editing the existing project data. In the method, existing member connections are made between members, to projects, to test plans, to security, to approvals. The users can use the interfaces provided in FIGS. 4-8 for creating new member connections to projects, and editing the existing member connections to projects in the central database. Then, a new member access is provided to the project-related documents when the new member connections to the project. As a precaution, security credentials can be received from at least one user before the user can view or edit information from the central database. Security if used for conditioning the accessibility of project information based on the at least one user's security credentials. In addition, security can be used for conditioning user's ability to edit project information based on the at least one user's security credentials.

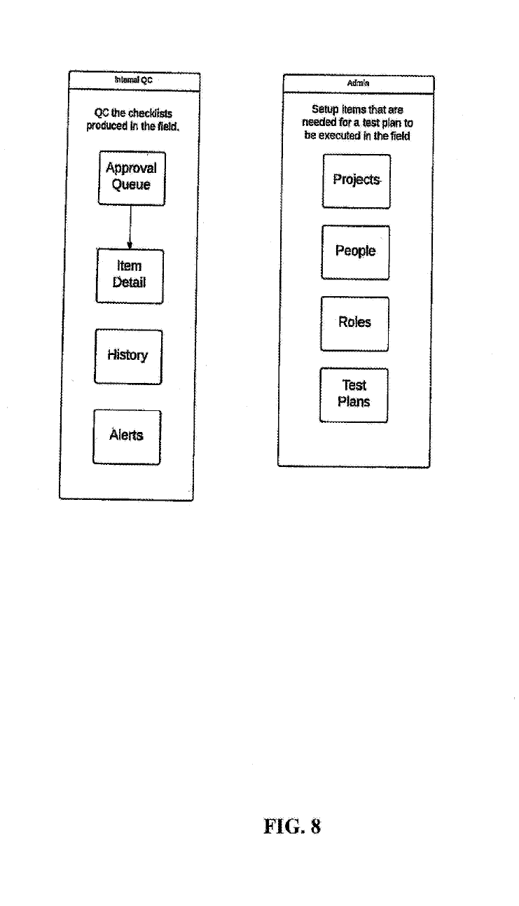

With reference to FIG. 8:

QC Users:
Review submitted checklists and either approve or reject according to their pre-defined criteria.
View the history of projects that pertain to that user. This would include checklist submissions, rejections, alerts, etc.
The ability to generate alerts on a per-user, per-project, or per-organization basis.

Administrators
Adding of new ITPs and their associated checklist templates.
Adding new users, defining their permissions/roles within the system and configuring their initial account information.
Setting up new projects including defining initial station locations.
Will be able to manage a library of documents including checklist templates, specifications and criteria to support reusability in the process of setting up inspection test plans.

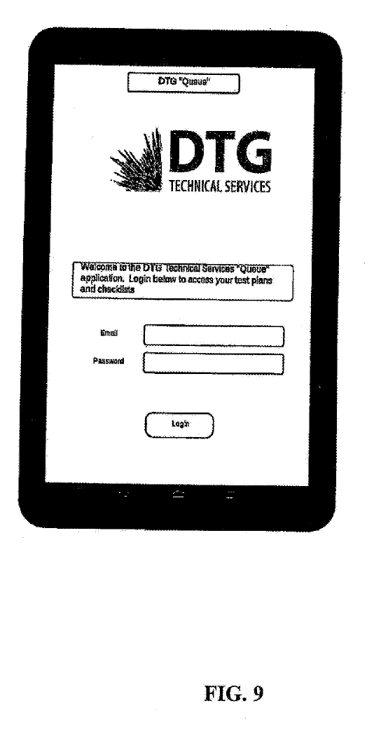

FIG. 9 depicts a Login screen which will accept a standard email and password as means to access the application. This email and password will be defined as part of the registration and on-boarding process that is conducted by staff at DTG via the web portal.

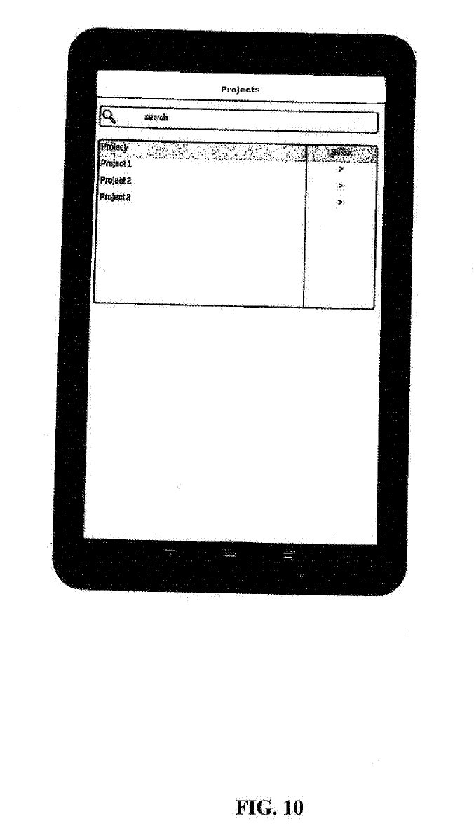

FIG. 10 depicts a Projects screen which will support the viewing of active projects, the ability to search for projects by project name and selecting of the project to be worked on.

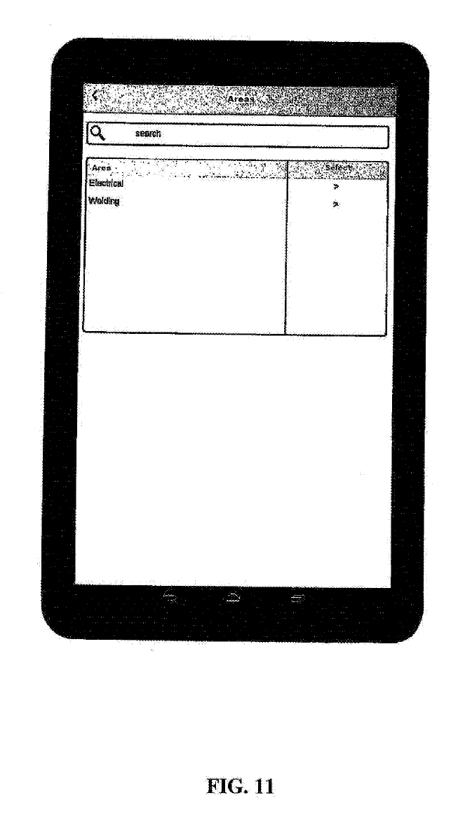

FIG. 11 depicts a Choose Area screen which is similar to the Projects screen, but allows for the selection of specific areas within a project. Each area listed would represent a project broken down by its respective discipline.

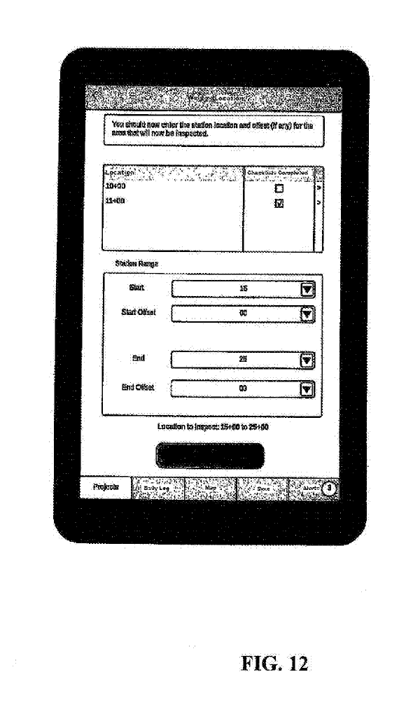

FIG. 12 depicts a Station and Offset Definition screen which is meant to be used to enter the specific station (location) that will be inspected. The user will either select from a list of already-known station numbers (station numbers previously entered by the user) or will free-hand enter the station number. The offset would allow for similar data entry as to indicate a specific inspection site, specified in feet from the previous station location. A range of stations for inspection could be defined on this screen or a single point could be entered by leaving the End and End Offset fields empty. This screen would serve as the spot a user returns to after the successful submission of a completed checklist. By always returning to this view upon checklist completion, the user can easily proceed to the next inspection site and repeat the inspection process in a streamlined manner.

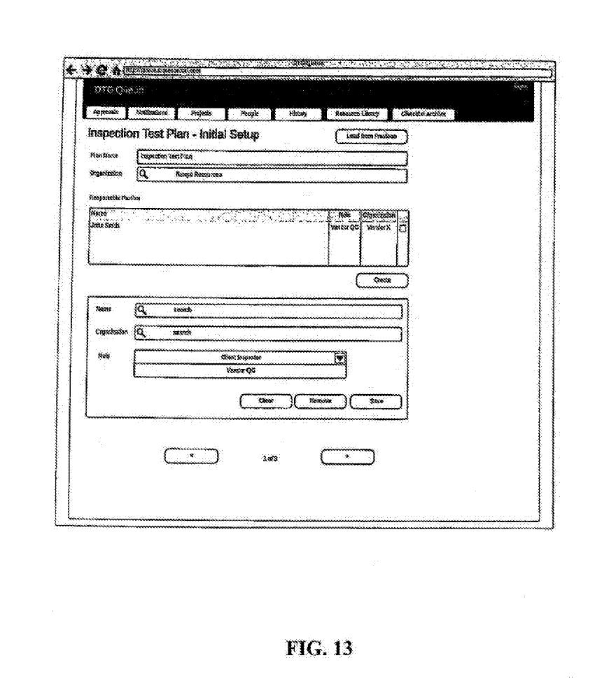

FIGS. 13-15 depict the building of the ITP is distributed across three separate screens that create a wizard-like workflow. This sequential workflow is designed to match the naturally hierarchical relationship that exists within a test plan. This screen is primarily intended to be used by DTG and others that might be defined as system administrators.

FIG. 13 depicts an Initial Setup screen which is the first of the ITP building screens. This screen is meant to be the starting point in the creation of the test plan. The user will be able to name the plan and select an organization for which the plan is being built. Responsible parties will also be added on this screen to fill in the primary points of responsibility. The adding of parties would be done by inserting a person's name, the organization they are representing, and the role that they will be playing within the project. This screen will also support loading of a previously defined ITP that can then be used as the basis for a new test plan.

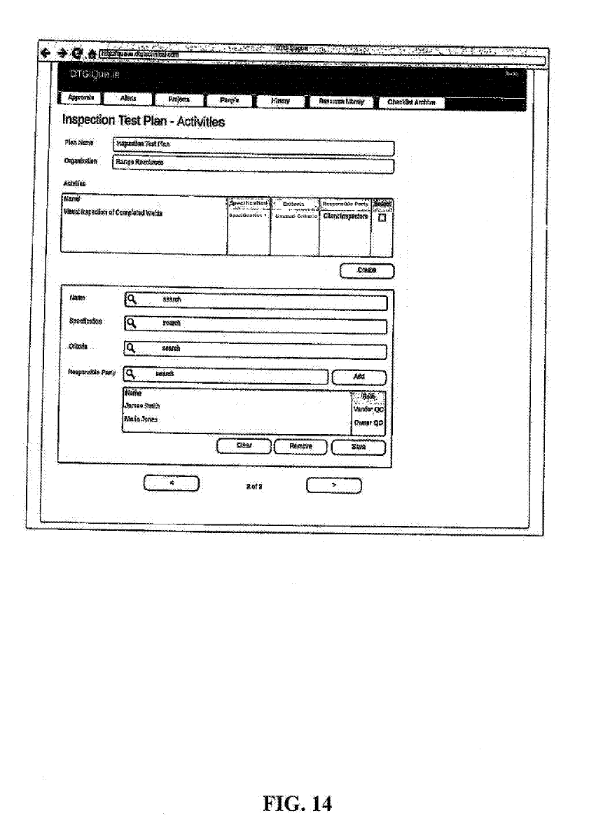

FIG. 14 depicts an Activities screen which is the second of the ITP building screens. In this screen the user will add activities to the ITP. Each activity is made up of the activity name, responsible party, the related acceptance criteria and specification. The acceptance criteria and the specification are chosen from the template documents that exist in the resource library.

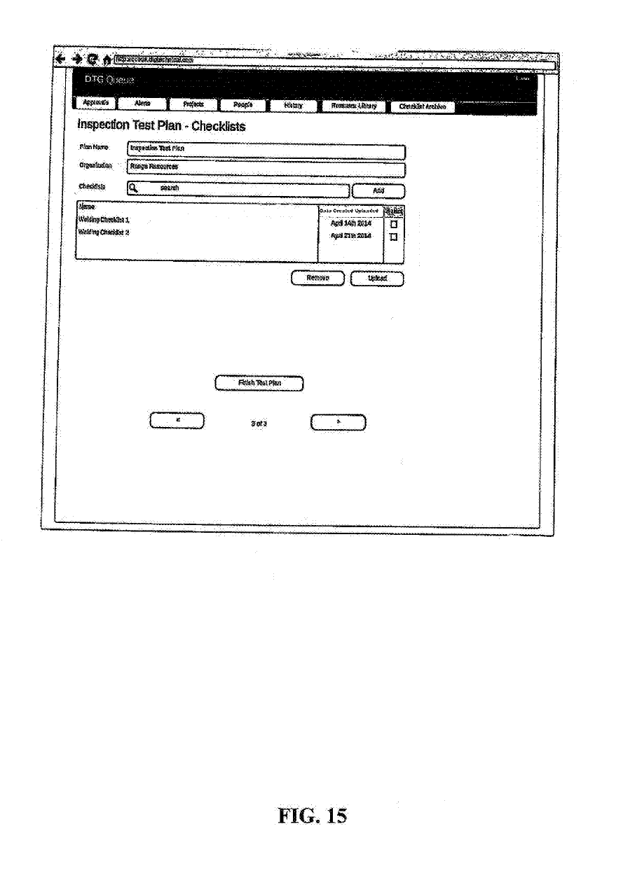

FIG. 15 depicts a Checklists screen which is the third of the ITP building screens. This screen is the final step of the ITP building process and is where a user builds the checklists into the document. Checklists can either be added from the resource library or can be uploaded to the test plan ad-hoc. It should be noted that removing a checklist from this screen will not affect the repository of checklists in the resource library.

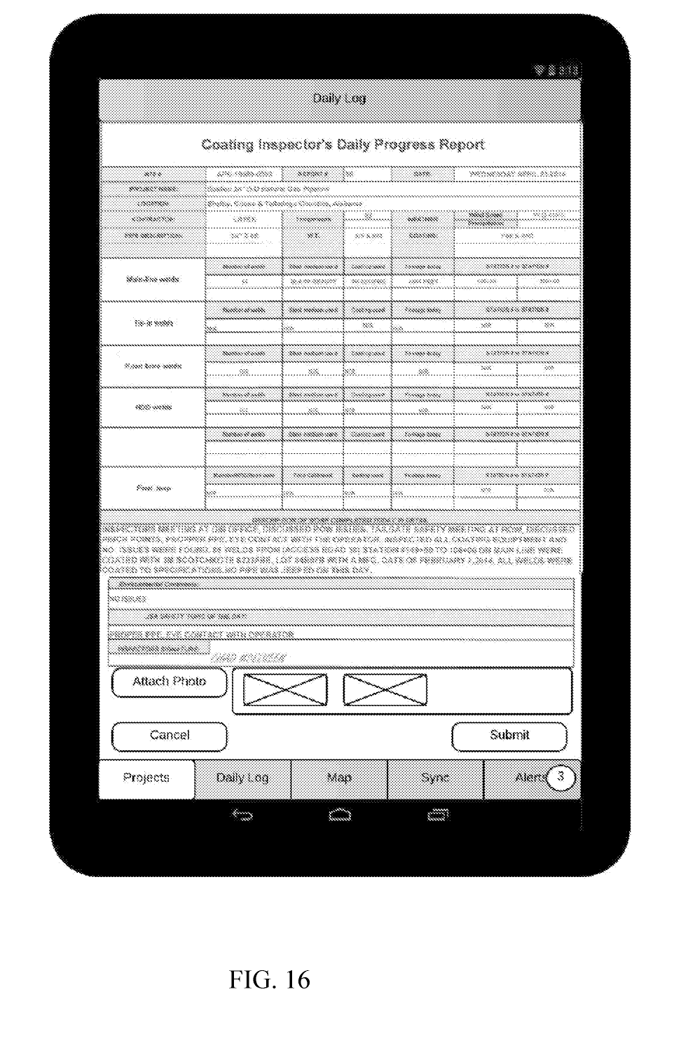

FIG. 16 depicts a Daily Log screen which represents an opportunity for the user to enter the information for their project logs on a daily basis using a standard PDF-based form. It would be expected to mirror the inspection checklist screen in both appearance and behavior. This display would include industry standard information such as date, location, current weather conditions, a general description, etc.

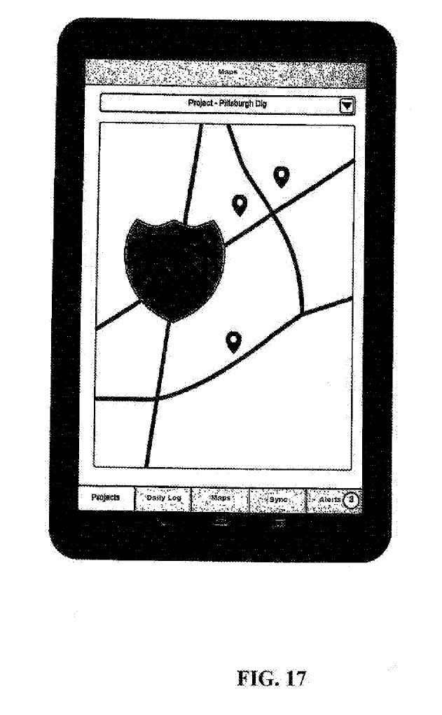

FIG. 17 depicts the screen view of a Maps tab. This screen gives a visual representation to the user of the current state of the project or allow the user to review the status of other projects they have worked on. This screen shows the general geography and elevations of the total dimensions of a project site. It would display markers indicating project stations, offsets, and their respective inspection statuses. The markers would be color-coded to provide a quick indicator of which stations are currently being worked on, which ones have already been inspected, and which ones still have inspections that are yet to be completed. The markers would also be used as a means of navigating back to a specific location's inspection test plan.

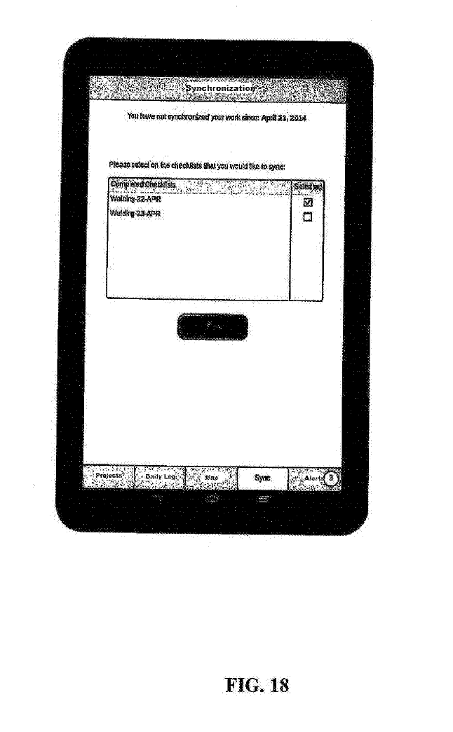

FIG. 18 depicts a Synchronization screen which supports the ability to work in a disconnected fashion for remote project sits where network connectivity is minimal. All data entered by a user remains on the device, including completed checklists, daily logs, revised locations/location offsets, etc., until the user initiates a synchronization. The user can review the synchronization screen to determine when they last submitted their work from the tablet, as well as which of their finished work items they would like to submit.

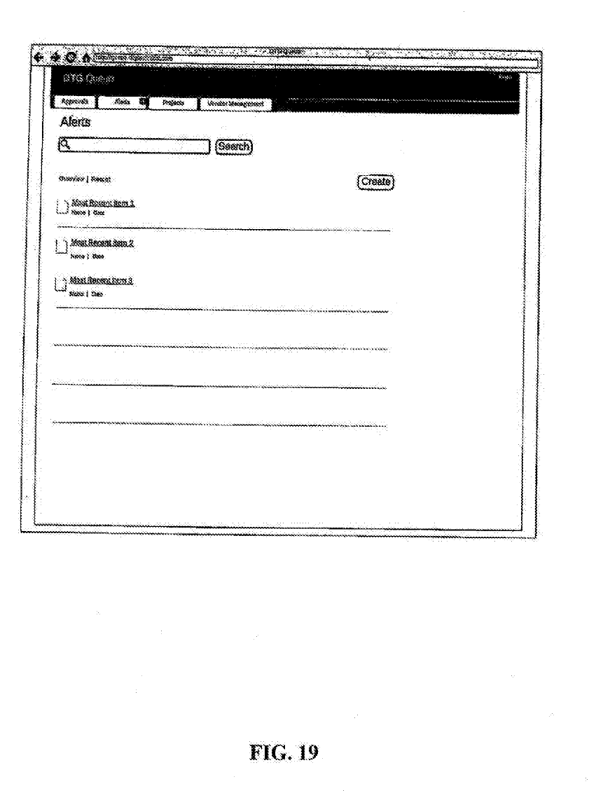

FIG. 19 depicts an Alerts tab. Alerts are generated from within the web portal and are used to important alert a user working at a project site to important information. Example alerts would include missing checklists, indications of being overdue to synchronize completed checklists and general team broadcasted notifications. Selection of a specific alert would navigate the user to a view showing that alert's detailed message as well as presenting them with an opportunity to acknowledge the alert.

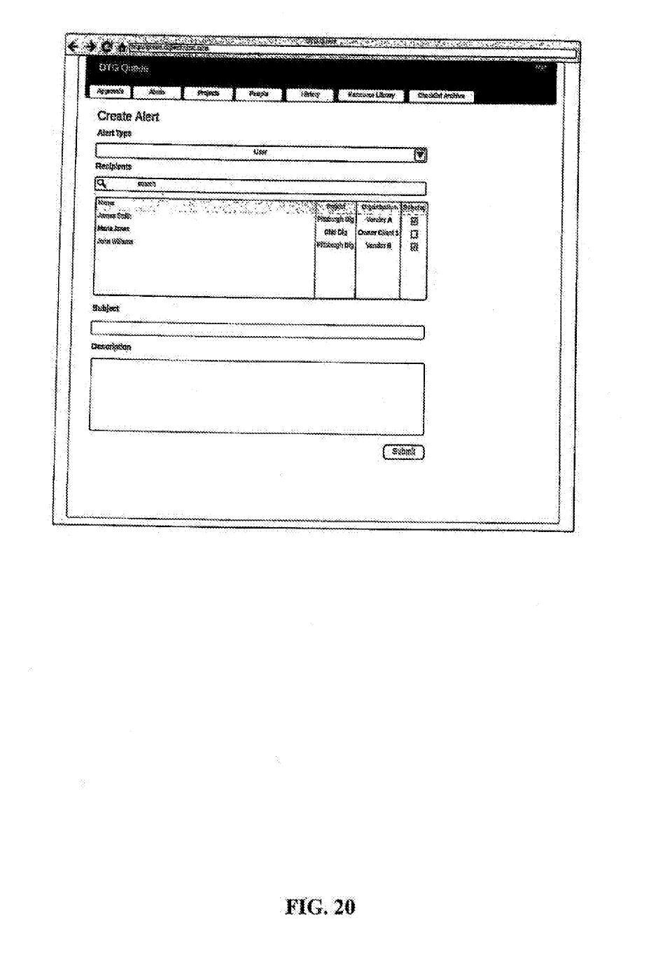

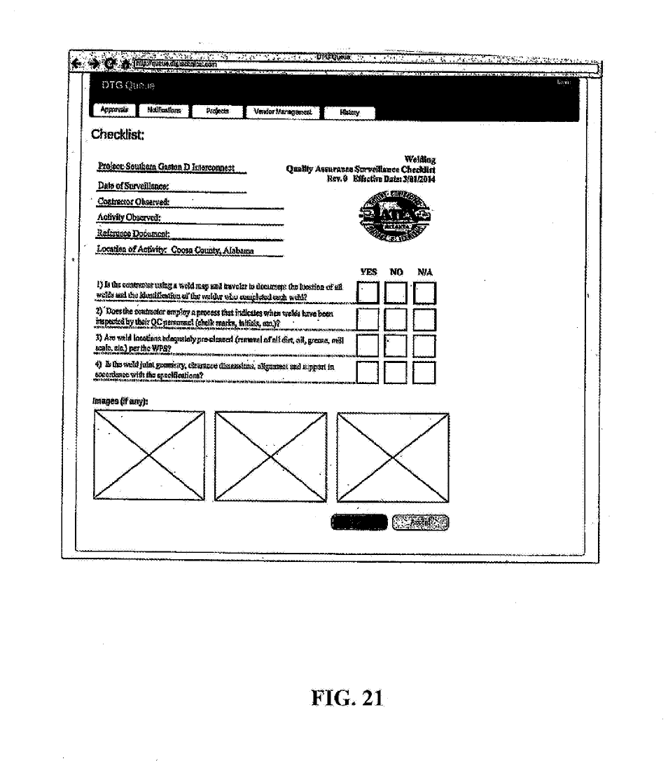

FIGS. 20-21 depict the set of screens used for creating alerts, as well as the work list for viewing alerts within the system. Each alert can be targeted at a specific user, can be sent to all users involved in a single project, or can be broadcast across the system. Potential recipients of an alert can be filtered via search criteria depending on the desired type of alert. If you are targeting an alert for a specific user, the search functionality would filter by the person's name. If the alert is meant to be broadcast across a project, the search filters by project named (or identifier). System alerts would require no selection by the user and would be broadcast to every current user of the system.

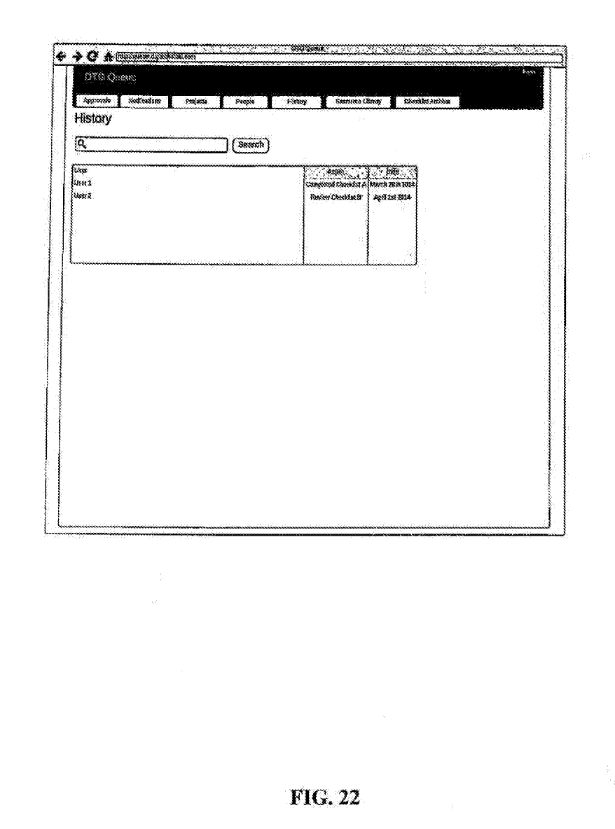

FIG. 22 depicts a Review Checklist screen for reviewing a completed checklist, its associated images, and allow the QC staff to either reject or accept the completed checklist. Both the acceptance and rejection would prompt the user with a modal display allowing for a final confirmation of the associated action. If a checklist is rejected, the user is presented with an additional field to supply a reason for why the checklist is being rejected. Rejecting a checklist would regress the state of the checklist back to the previously responsible party, potentially sending it back to the one who executed the checklist originally for corrections. Acceptance of a checklist would move it forward in its QC review process and potentially into archived storage, if and when it was accepted by the owner client's QC inspection point. If a QC user rejects a checklist, the QC user will be prompted to provide a reason for the rejection, and the checklist will revert back to its previous owner for revisions, and an alert will be generated notifying all parties involved of the rejections. Accepting or rejecting the checklist will navigate the user back to their approval queue.

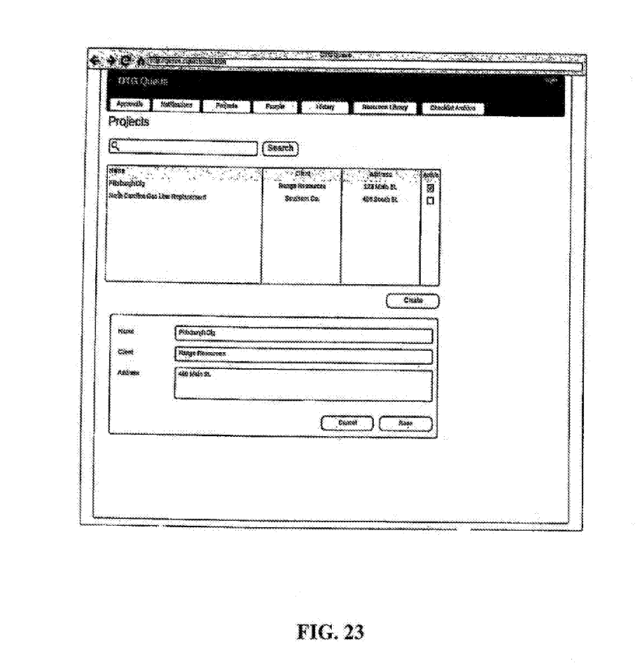

FIG. 23 depicts a History screen which is a place to review all activities as they relate to any given project. This list would include the adding of projects, completion/rejection of checklists and all related alerts. This is the means by which the system's audit trail will be accessed.

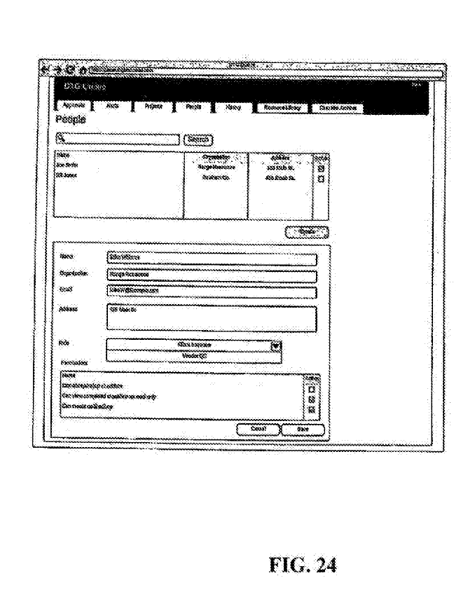

FIG. 24 depicts a Managing Projects screen which is intended to handle all requirements for both creating and updating existing projects. A project can be searched for by name and, once it is located, can be selected from the list. Once an existing project is selected, a sub-screen is displayed below the list to support updating all pertinent information as it relates to the project, including project name, the associated owner client the address of the project. Once the updates are entered, the user can save and retain the updates, or cancel and dismiss the updates.

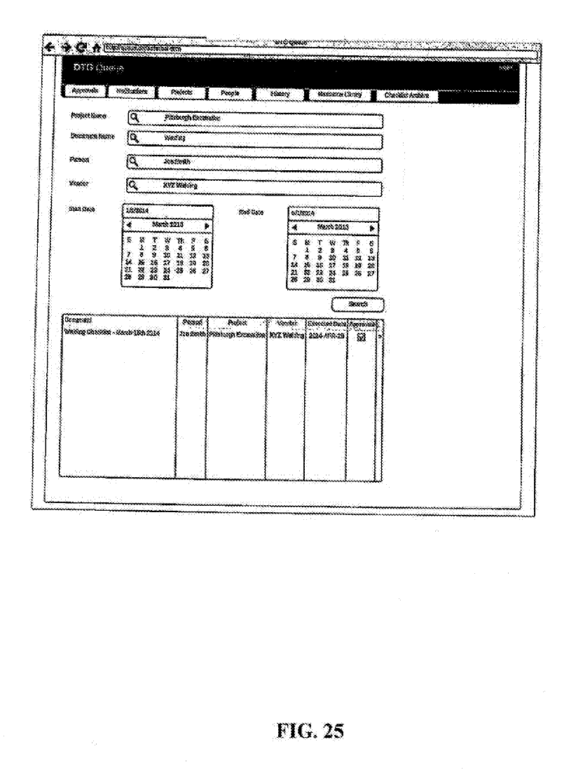

FIG. 25 depicts a Managing People and Roles screen which is intended to manage all users that relate to a project and is primarily intended for use by administrators of the system. It supports searching for a person by name and allowing the desired individual to be selected from the resulting search results. Once selected, managing existing users have a workflow similar to managing projects in that an entry form is presented to the user below the list of people. New staff members can be entered into the system from this display as well. All newly created people within the system will be sent an invitation via the email address provided. The email based invitation will provide their initial on-boarding process, including the initial setting of a password for the user. The entry form will support entering data related to the use, such as name and address, but also set up their default role in a system and their permissions. Roles define what the intended purpose within the system is, such as defining in whether an individual is a Vendor QC, Owner QC, or system administrator. Permission sari intended to allow for the addition or removal of very specific abilities to do tasks within the system. An example of this use case would be taking someone who has permission to both view submitted checklist and to accept/reject them. The permission that controls accepting/rejecting checklists could be removed, but that individual would still have the ability to look at checklists submitted to the system. Both roles and permissions would be pre-defined lists within the system.

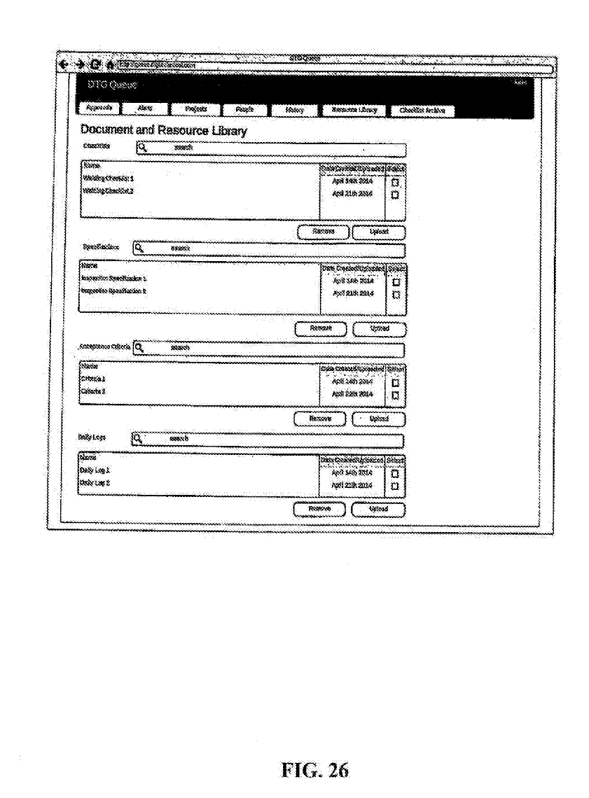

FIG. 26 depicts a Checklist Archive/Search screen which supports the searching of checklists that had been approved at each step of the QC process. This would support searching of archived documents by various fields including project name, document name date ranges, and inspection points, i.e., the names of responsible parties. Documents would be accessible from this view once they are submitted and have been progressed forward in the checklist lifecycle. For example, a newly submitted checklist would not be reviewable until it was fully vetted by the vendor QC in an early set within the lifecycle.

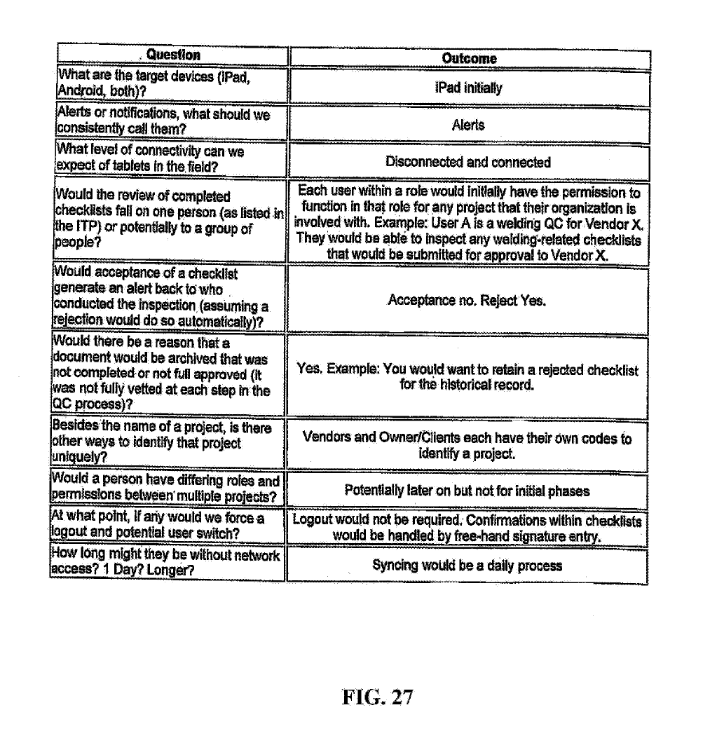

FIG. 27 depicts a Resource Library screen which serves as a repository of document templates to be used in the system as someone works to define an inspection test plan. The initial document template categories that would be included in the library would be checklists, acceptance criteria, specification documents, and daily logs. Each document template library section would be searchable by the template's name. This screen would allow for the update of new PDF templates, as well as remove templates that have been depreciated.

Although the invention has been described in detail for the purpose of illustration based on what is currently considered to be the most practical embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. An electronic project and data management system, comprising:
a central database accessible via a server controller, the central database being configured to store project information, project-related documents, and an archive of past projects and approved project-related documents;
an interface, for data management with electronic access to the central database, the interface for data management comprising a web portal, the web portal being configured for a user to view, create, and edit the project information in the central database, and view, create, and edit member connections to projects, the user first logging in securely before the user can view, create, or edit information from the central database, the web portal automatically providing member access to the project-related documents when a new member connection to the project is created for the user, and the interface further being configured to allow or deny the logged-in user access to the project information, and allow the logged-in user to, or prevent the logged-in user from, editing the project information from the central database, whereby the logged-in user's ability to access or edit changes as determined by the user's role and membership in selected projects; and
a foreman's device with electronic access to the central database.

2. The system of claim 1, wherein:
the project-related documents are automatically connected to members higher up a review hierarchy when the project-related documents are approved by members lower down the review hierarchy, and the project-related documents are automatically connected to the members lower down the review hierarchy when the project-related documents are rejected by the members higher up the review hierarchy;
managing project members create inspection test plans, edit the inspection test plans, and save the inspection test plans to the central database, the inspection test plans being configured to be accessed by the foreman's device, and inspection checklists can be saved to the inspection test plans;
the foreman's device is configured to run software adapted for a foreman to view project information, create and save electronic project-related documents, and transmit the project-related documents to the central database;
the foreman must use security credentials to log in to the foreman's device and access project-related data, and the foreman's device is configured to receive, view, and edit the project-related data as made accessible by the foreman's project connections;
the foreman's device is configured for the foreman to create new inspection checklists, edit the inspection checklists, submit the inspection checklists to the central database, attach photographs to the inspection checklist, and submit the inspection checklist to the central database;
the central database is configured to store inspection checklists and templates for creating the inspection checklists, the templates being configured to be edited, saved, and deleted from the central database via the foreman's device or other electronic access by a member with sufficient administrative permission; and
the project members receive alerts when important project updates occur or when a new document awaits their approval or revision.

3. The system of claim 2, wherein the foreman's device is connected to a synchronous data connection, and the foreman's device is configured to transmit information to the central database with the synchronous data connection, or transmit information by the foreman manually triggering synchronization if the foreman's device was operated previously without data connectivity, the foreman's device being further configured to access maps, daily logs, and alerts as each relate to a selected project.

4. A method of managing electronic project-related data, comprising:
displaying an interface for data management;
transmitting information between the interface and a central database;
storing project information, project-related documents, and an archive of past projects and approved project-related documents in the central database;
displaying the interface through a web portal for a user;
displaying existing project data, creating new project data, and editing the existing project data in the central database;
displaying existing member connections to projects, creating new member connections to projects, and editing the existing member connections to projects in the central database;
providing a new member access to the project-related documents when a new member connection to a project is created for the user;
receiving security credentials from the user before the user can view or edit information from the central database;
conditioning the accessibility of project information based on the user's security credentials; and
conditioning the user's ability to edit project information based on the user's security credentials.

5. The method of claim 4, further comprising:
connecting the project-related documents to members higher up a review hierarchy when the project-related documents are approved by members lower down the review hierarchy;
connecting the project-related documents to the members lower down the review hierarchy when the project-related documents are rejected by the members higher up the review hierarchy;
creating inspection test plans, editing the inspection test plans, and saving the inspection test plans to the central database;
transmitting the inspection test plans to a foreman's device and saving inspection checklists to the inspection test plans;
transmitting project information to the foreman's device, creating and saving electronic project-related documents on the foreman's device, and transmitting the project-related documents to the central database;
receiving security credentials from the foreman, logging in the foreman to the foreman's device, transmitting project-related data to the foreman's device, displaying project-related data on the foreman's device, and editing project-related data on the foreman's device as defined by the foreman's project connections;
creating new inspection checklists on the foreman's device, editing the inspection checklists on the foreman's device, and transmitting the inspection checklists from the foreman's device to the central database;
attaching photographs to the inspection checklist and transmitting the inspection checklist to the central database;
storing inspection checklists and templates for creating the inspection checklists;
editing templates, saving templates, and deleting templates from the central database via the foreman's device or other electronic access by a member with sufficient administrative permission; and
alerting the user when important project updates occur or when a new document awaits their approval or revision.

6. The method of claim 5, further comprising:
connecting the foreman's device to a synchronous data connection and transmitting data from the foreman's device to the central database with the synchronous data connection, or alternatively, transmitting data to the central database when prompted manually by the foreman's device after previously being operated without data connectivity; and
displaying maps, daily logs, and alerts on the foreman's device as each relate to a selected project.

7. A computer readable medium containing a program for managing an electronic data management system network, the program comprising the steps of:
displaying an interface for data management;
transmitting information between the interface and a central database;
storing project information, project-related documents, and an archive of past projects and approved project-related documents in the central database;
displaying the interface through a web portal for a user;
displaying existing project data, creating new project data, and editing the existing project data in the central database;
displaying existing member connections to projects, creating new member connections to projects, and editing the existing member connections to projects in the central database;
providing a new member access to the project-related documents when a new member connection to a project is created for the user;
receiving security credentials from the user before the user can view or edit information from the central database;
conditioning the accessibility of project information based on the user's security credentials; and
conditioning the user's ability to edit project information based on the user's security credentials.

8. The program of claim 7, further comprising the steps of:
connecting the project-related documents to members higher up a review hierarchy when the project-related documents are approved by members lower down the review hierarchy;
connecting the project-related documents to the members lower down the review hierarchy when the project-related documents are rejected by the members higher up the review hierarchy;
creating inspection test plans, editing the inspection test plans, and saving the inspection test plans to the central database;
transmitting the inspection test plans to a foreman's device, and saving inspection checklists to the inspection test plans;
transmitting project information to the foreman's device, creating and saving electronic project-related documents on the foreman's device, and transmitting the project-related documents to the central database;
receiving security credentials from the foreman, logging in the foreman to the foreman's device, transmitting project-related data to the foreman's device, displaying project-related data on the foreman's device, and editing project related data on the foreman's device as defined by the foreman's project connections;
creating new inspection checklists on the foreman's device, editing the inspection checklists on the foreman's device, and transmitting the inspection checklists from the foreman's device to the central database;
attaching photographs to the inspection checklist and transmitting the inspection checklist to the central database;
storing inspection checklists and templates for creating the inspection checklists;
editing templates, saving templates, and deleting templates from the central database via the foreman's device or other electronic access by a member with sufficient administrative permission; and
alerting the user when important project updates occur or when a new document awaits their approval or revision.

9. The program of claim 8, further comprising the steps of:
connecting the foreman's device to a synchronous data connection and transmitting data from the foreman's device to the central database with the synchronous data connection, or alternatively, transmitting data to the central database when prompted manually by the foreman's device after previously being operated without data connectivity; and
displaying maps, daily logs, and alerts on the foreman's device as each relate to a selected project.
